(19) United States
(12) Patent Application Publication
(10) Pub. No.: US 2006/0247106 A1
(43) Pub. Date: Nov. 2, 2006

(54) Stationary kick practice stand

(76) Inventor: Johnny G. Peavey, Kingwood, TX (US)

Correspondence Address: Johnny G. Peavey, 2503 Poplar Park Drive, Kingwood, TX, 77339, US

(21) Appl. No.: 11/120,073

(22) Filed: May 2, 2005

(51) Int. Cl. A63B 71/00; A63B 69/34; A63B 69/00; G09B 19/00

(52) U.S. Cl. 482/83; 482/8; 434/247

(57) ABSTRACT

An apparatus is provided for aiding students to perfect their form of kicking. A box is fixedly attached to a base with a telescoping post. The post can be arranged to adjust the height of the box. Once adjusted, the apparatus is placed in a room and the base made immobile. When suitably arranged, the box gives a visual cue to the student of the parameters of a proper kick. The box is large enough to enable the student to place their foot and leg into the box while practicing the kick. If the student's body touches the box, the student knows that the kick is out of optimum bounds, and to adjust their kicking style accordingly. Students may thus practice their kicks and be given tactual feedback on their progress and technique.

### BACKGROUND OF THE INVENTION

1. Field of the Invention

The present invention is related to sporting equipment. More particularly, the present invention is related to an apparatus to aid karate students to develop better kicking habits without incurring injury.

2. Background of the Related Art

The art of karate includes moves and routines that require kicking. To advance within the art (i.e., achieve higher ranked belts), students must perfect their form, including their form of kicking. Various types of kicks are taught to karate students (such as the side kick, roundhouse kick, front snap kick, axe kick, hook kicks, etc.). In the past, students have used other students and kicking bags to practice their kicking techniques. The practice of using other students and kicking bags to practice kicking techniques places the “target” student in some danger if the practice kicker is not experienced. Moreover, the practice kicker must contend with the understandable desire of the target student to move away from the path of the kick at judicious moments. Hitting a practice target or kicking bag does not address the fundamental problem of knee, leg and foot positioning in order to deliver a proper kicking technique. There is a need, therefore, in the art for an apparatus that enables students to practice kicking techniques without injury to themselves or to others.

### SUMMARY OF THE INVENTION

The present invention solves some of the problems inherent in the prior art by providing a mechanism for enabling Martial Arts students to perfect their kicking form. A box is fixedly attached to a base via a post. The post can be adjusted to vary the height of the box to suit the particular student. Once adjusted, the box gives a visual cue to the student of the parameters of a proper kick. The box is large enough to enable the student to place his or her foot and leg into the box while practicing the kick. If the student's body touches the box, the student knows that the kick is out of optimum bounds, and to adjust their kicking style accordingly. The box, while fixedly attached to the post, may be removed and replaced with a box of a different shape that is optimized for a different style of kick. Students may thus practice their kicks and be given tactile feedback on their progress and technique.

In another embodiment of the present invention, a video feedback system allows the student to record the kick for immediate or delayed playback regarding their progress and technique. By optimizing foot and leg positioning, the student can more accurately perform kicking tasks.

In another embodiment, the system is equipped with a timing device and/or a video camera to allow the student or the instructor to evaluate the speed, power and technical correctness of the kick.

In another embodiment, the system is also equipped with an adjustable mechanical foot brace with ankle strap. The ankle strap and foot brace can be adjusted to fit the particular student's size and stature. The mechanical foot brace can also be pivoted out of the way in order for the unit to be used without a foot brace. Without the foot brace, the user will be required to stand a prescribed distance from the kicking tunnel (box) in order to assure proper kicking technique.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a side view of the stand according to the teachings of the present invention.

FIG. 2 is a front view of the main tube according to the teachings of the present invention.

FIG. 3 is a side view of the apparatus according to the teachings of the present invention.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered by the appended claims.

### DETAILED DESCRIPTION

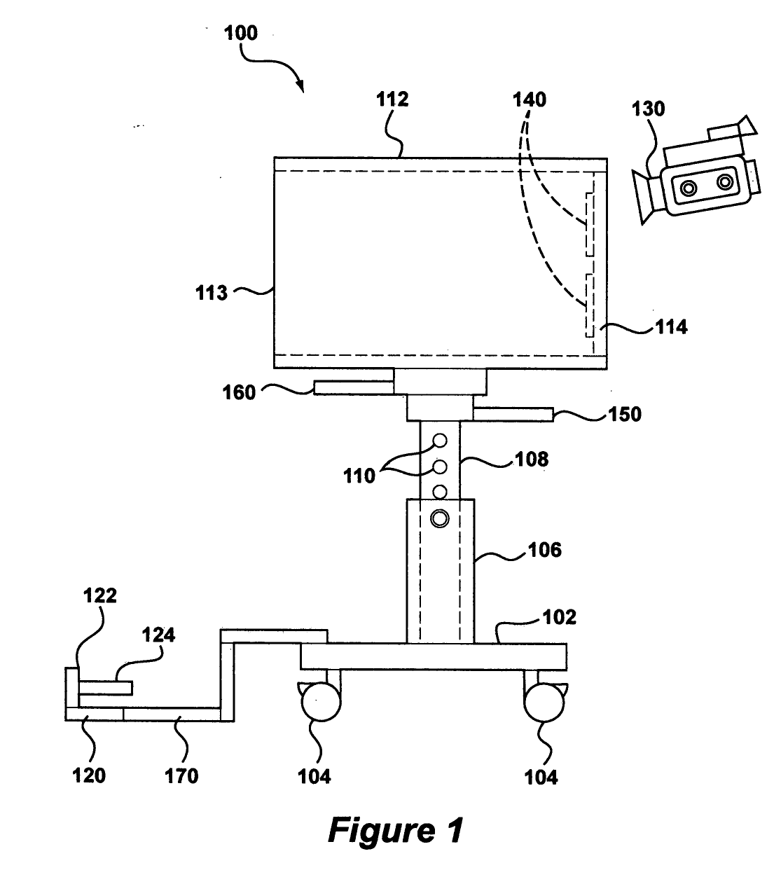

FIG. 1 illustrates a side view of an embodiment of the present disclosure. The apparatus 100 is provided with a base 102. The base 102 can be made mobile by use of one or more casters 104. In operation, the base is made steady or immobile. Thus, if casters 104 are used, they could be made to lock, or some other mechanism may be employed to fixedly attach the base to the floor. In another embodiment, the base 102 is heavy to give the apparatus 100 a low center of gravity for improved stability, particularly if mounting directly to the floor is not foreseen.

A post 106 is fitted upon the base 102. The post 106 can come in a variety of forms. In one embodiment, the post 106 is a large spring, which will enable the box 112 to move when a student accidentally hits it (so as not to injure the student). Alternatively, as illustrated in FIG. 1, the post 106 contains a telescoping portion 108 that is slideably arranged to the lower portion 106 so that the height of the box can be adjusted. Although a wide variety of adjustment mechanisms are possible with the embodiments disclosed herein, the embodiment of FIG. 1 shows the telescoping portion 108 fitted with a series of holes 110, preferably along a line called an adjustment line, through which pins (not shown) may be placed. The lower portion 106 may also be fitted with a hole 110, so that the pin (not shown) may be slid through the hole 110 in the post 106 and a corresponding hole 110 in the telescoping portion 108, thereby locking the lower post 106 and the telescoping portion 108 together at the desired height.

In an embodiment, the post 108 is fitted with attitude adjustment mechanisms 150 and 160 that allow the attitude of the box 112 (that is attached to the attitude adjustment mechanisms 150 and 160, to be adjusted (e.g., the yaw angle, pitch angle and roll angle) so that a greater number of kicks for a larger number of students may be attempted with the same box 112 configuration. The box 112 may also be fitted with sides 113 that can be swung open for those kicks (such as the roundhouse kick) that have wide or lateral swinging motions.

In one embodiment, the attitude adjustment mechanisms 150 and 160 enable the box 112 to be rotated up to 90 degrees (e.g., vertical) as opposed to the horizontal position illustrated in FIG. 1. Such flexibility in attitude angle enables the same box 112 to service more than one type of kick. In addition, opening one of the sides 113 of the box 112 while the adjustment mechanisms 150 and 160 have placed the box 112 in the vertical position enables other types of kicks to be performed without removal or replacement of the box 112.

In one embodiment, the telescoping portion 108 may be constructed of Lexan and may have one or more pads. The flexibility of Lexan enables the box to move in response to being kicked by a student, and thus reduce the likelihood of injury to the student. Similarly, the pads can be fitted to the box 112, sides 113, telescoping portion 108, post 106, and base 102 to help prevent injury to a student who commits an errant kick.

The box 112 can come in a variety of shapes and sizes. Size, of course, can vary depending upon the size of the student involved, with smaller boxes for younger students, and larger boxes (of the same general shape) for adolescents and adults. Conversely, the shape of the box can be varied to accommodate different styles of kicks, such as side, roundhouse, front snap, axe, and hook kicks. The box 112 can be made of a variety of materials, although plastic, carbon fiber, lexan or wood are suggested, depending upon the need for durability, flexibility, and the cost of procurement and construction, although other materials could be used. Generally, it would be better if the box were relatively lightweight, so that logistical problems related to the removal and replacement of the box 112 by younger assistants is ameliorated, and that the center of gravity of the apparatus 100 be as low as possible for greater stability.

In another embodiment, the apparatus 100 is fitted with a foot brace 120, which may be adjustably mounted onto the base 102 as illustrated in FIG. 1. The brace 120 enables a student to place their foot in the proper position vis-à-vis the box 112. The foot brace 120 can be adjusted both inward and outward (longitudinally) from the base 102 to enable students of various sizes to be placed comfortably in position next to the box 112. For example, younger/smaller students would normally be positioned closer to the box 112 (with the box lowered) and thus the foot brace 120 would be positioned closer to the base 102. Similarly, larger students would have the foot brace 120 placed farther away (and the height of the box positioned upward). The foot brace 120 can also be adjusted laterally with respect to the box 112. For some kicks, either the right foot or the left foot leads, depending upon the style of kick and whether the left or right foot is the striking foot. Consequently, it is best to have the foot brace 120 adjustable along a range of positions laterally (side to side) with respect to the box 112 so that the student can start the kick in the proper stance. An ankle strap 124 may be optionally placed at the end 122 of the brace 120. The optional ankle strap 124 ensures that the foot does not move out of position during the kick.

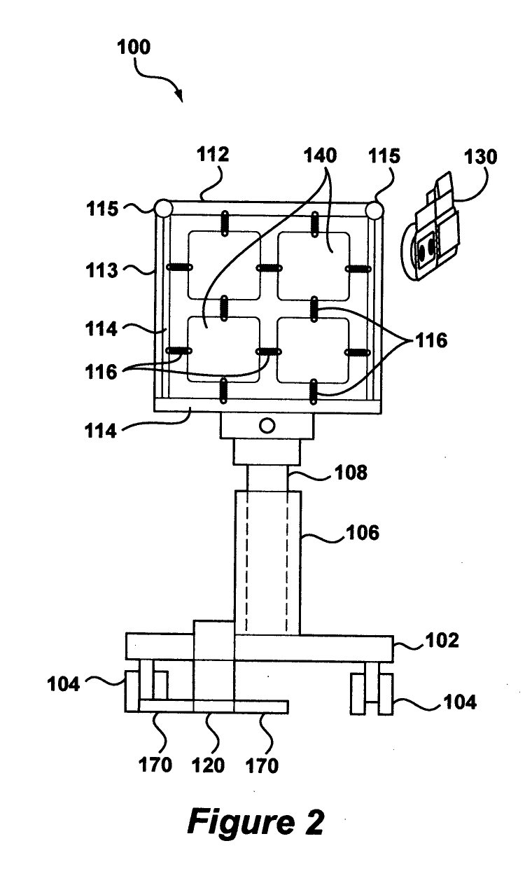

In another embodiment, one or more sensors 140 can be placed within the box 112 as illustrated in FIG. 2 in order to measure the force of the kick. The sensor 140 may be placed at various places within the box 112 and can, for example, be made the aim point for the student. The sensor 140 may be equipped with a force sensor, such as a piezoelectric sensor. Depending upon the placement of the sensor 140, whether the student performed the kick improperly by detecting where within the box 112 the student touched the box 112. Thus, when the student strikes the sensors 140, they can be graded both on their technique, as well as the force and/or placement of the kick.

In another embodiment, one or more video cameras 130 may be position with respect to the apparatus 100 in order to record the kick. Both the video camera 130 and/or the sensors 140 are connected to a recording device, such as a VCR, DVD, or personal computer (not shown) in order to record the measurements for later analysis and commentary.

In another embodiment, the sensor 140 can be included with (or act as) a timing mechanism to record the amount of time it takes the student to perform the kick. For example, the timer may be equipped with a timer pad 170 upon which rests one of the student's feet at the beginning of the kick. For example, the timer can be started when the student lifts his/her foot from the pad at the start of the kick, with a another triggering event when the student hits one or more of the sensors 140, and another triggering event when the student places their kicking foot back onto the pad 170. In this way, the complete duration of the kick (setup, hit, and return) can be measured. Alternatively, the timer in the sensor 140 may be initiated by the instructor. Impact with the sensor 140 or placement of the foot back onto the starting pad 170 by the student can be used to stop the timer. As with the other example, the measurements may be forwarded to a recording device, such as a personal computer. Similarly, video taken from camera 130 may also be forwarded to the same or different recording device for later review.

FIG. 2 is a front view of the apparatus 100 illustrated in FIG. 1. FIG. 2 illustrates additional features for alternate embodiments. Specifically, an arrangement of sensors 140 is illustrated at the back of the box 112. In the embodiment of FIG. 2, the sensors 140 are attached to the frame 114 of the box 112 by springs 116. Having the sensors 140 attached by springs 116 reduces the likelihood injury to the student when they strike with their kick.

FIG. 2 also nicely illustrates the flexibility of the sides 113 being hinged 115 on the top of the box 112. Alternatively, the sides can be hinged 115 from the bottom or the back of the box 112.

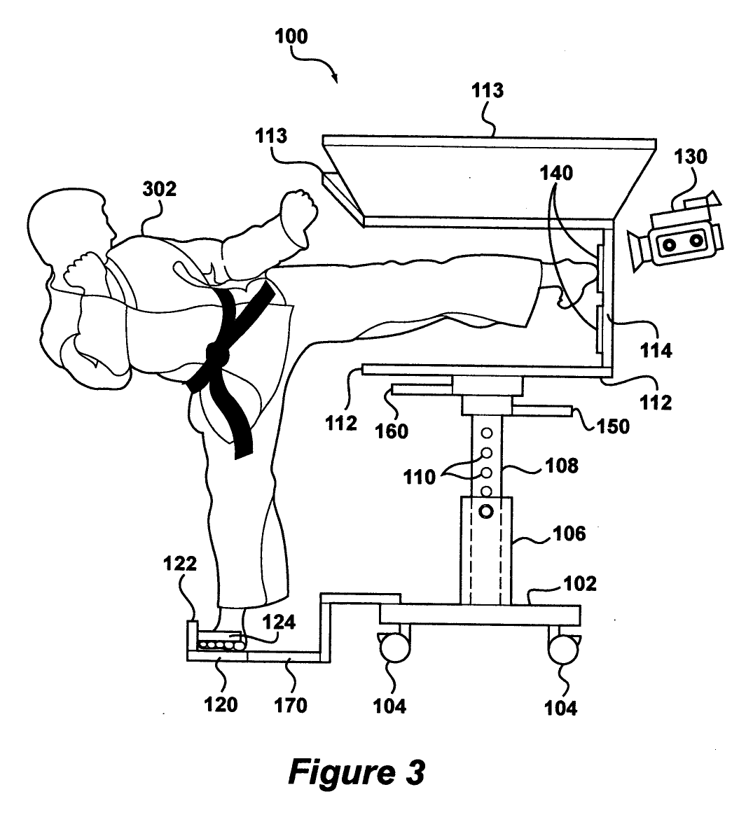

FIG. 3 is a side view of the apparatus 100 in use by a student 302. FIG. 3 illustrates the use of the ankle strap 124 in the brace 120. In addition, both sides 113 are swung open during the kick, and the camera 130 has sufficient line of sight to record the kick within the box 112, and even, perhaps, film some of the movement of the student's waist and upper body during the kick. FIG. 3 also illustrates the student 302 kicking one of the sensors 140.

The invention, therefore, is well adapted to carry out the objects and to attain the ends and advantages mentioned, as well as others inherent therein. While the invention has been depicted, described, and is defined by reference to the exemplary embodiments of the disclosure, such references do not imply a limitation on the invention, and no such limitation is to be inferred. The invention is capable of considerable modification, alteration, and equivalents in form and function, as well occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An apparatus for practicing kicks, comprising:
a base;
a post attached to the base; and
a box attached to the post;
wherein the box is constructed and arranged to enable a student to practice a kick.

2. The apparatus of claim 1, wherein the base has one or more casters.

3. The apparatus of claim 2, wherein two or casters are lockable.

4. The apparatus of claim 1, wherein the post a spring.

5. The apparatus of claim 1, wherein the post can be adjusted to change the vertical position of the box.

6. The apparatus of claim 1 further comprising an attitude adjustment mechanism between the post and the box.

7. The apparatus of claim 6, wherein the attitude adjustment mechanism enables the box to be positioned in a horizontal attitude.

8. The apparatus of claim 6, wherein the attitude adjustment mechanism enables the box to be positioned in a vertical attitude.

9. The apparatus of claim 6, wherein the attitude adjustment mechanism enables the box to be positioned at any angle between horizontal and vertical.

10. The apparatus of claim 1, wherein the box has a side that can be opened.

11. The apparatus of claim 1, wherein the box has two sides that can be opened.

12. The apparatus of claim 1, further comprising a video camera.

13. The apparatus of claim 1, further comprising a foot brace.

14. The apparatus of claim 13, further comprising an ankle strap attached to the foot brace.

15. The apparatus of claim 13, wherein the foot brace is adjustable longitudinally with respect to the box.

16. The apparatus of claim 13, wherein the foot brace is adjustable laterally with respect to the box.

17. The apparatus of claim 1, further comprising a sensor.

18. The apparatus of claim 1 further comprising a timer.

19. The apparatus of claim 17, wherein the sensor measures the force of the kick.

20. The apparatus of claim 1 further comprising a sensor and a timer, wherein the lifting of the student's foot from a pad starts the timer and the impact of the student's foot on the sensor triggers an event with the timer.
